(19) United States
(12) Patent Application Publication
(10) Pub. No.: US 2022/0379644 A1
(43) Pub. Date: Dec. 1, 2022

(54) SUBLIMATION PRINTING

(71) Applicant: Hewlett-Packard Development Company, L.P., Spring, TX (US)

(72) Inventors: Antonio GRACIA VERDUGO, Sant Cugat del Valles (ES); Carlota GALINDO QUINTAS, Sant Cugat del Valles (ES); Andrei Alexandru DAFINOIU, Sant Cugat del Valles (ES)

(73) Assignee: Hewlett-Packard Development Company, L.P., Spring, TX (US)

(21) Appl. No.: 17/771,894

(22) PCT Filed: Jan. 29, 2020
(86) PCT No.: PCT/US2020/015645

§ 371 Date: Apr. 26, 2022

(51) Int. Cl. B41M 5/035; B41F 16/00

(52) U.S. Cl. CPC B41M 5/035; B41F 16/00

(57) ABSTRACT

Examples relate to receiving image data of an image to be sublimation printed, wherein the image data comprising one or more colours to be printed, and a corresponding printing liquid density of the one or more colours. Based on the received image data, a sublimation energy to use to transfer printed printing liquid representing the image into a material is determined, and the determined sublimation energy is provided to a sublimator of a printer for transferring the image.

### BACKGROUND

Sublimation printing may be used to print designs on materials such as textiles. Printing liquid (e.g. ink) is transferred onto the material, and heating then fixes the printing liquid in the material by sublimation. Many different colours and image designs may be printed using sublimation printing.

### BRIEF INTRODUCTION OF THE DRAWINGS

Example implementations are described below with reference to the accompanying drawings, in which:

FIG. 1 shows a method for sublimation printing according to some examples;

FIG. 2 illustrates a method for determining a sublimation energy according to some examples;

FIG. 3 depicts a method of sublimation printing according to some examples;

FIG. 4 illustrates an example of an apparatus for sublimation printing according to some examples;

FIG. 5 shows an example of a sublimation printing system according to some examples;

FIGS. 6a-6d illustrate chroma or L*variation with temperature for different colour printing liquids at different printing liquid densities according to some examples;

FIG. 7 illustrates a relationship between sublimation temperature and printing liquid density for stable sublimation printing according to some examples; and

FIG. 8 depicts a computer readable medium according to some examples.

### DETAILED DESCRIPTION

Sublimation printing may be used to print designs on materials such as textiles and is a technology used in the polyester textile industry. First, a sublimation printing liquid (e.g. sublimation ink) is transferred onto the material, followed by heating the printed material. The temperature/energy change is applied during the second stage, once the printing with printing liquid is finished, to transfer/sublimate the printing liquid onto the final substrate. Heating at a sublimation temperature for a sublimation period of time sublimates the sublimation printing liquids. The heating also opens pores in the polyester textile into which the printing liquid becomes fixed. That is, the polyester fibers becomes vitreous and the sublimation printing liquid in a gas state can penetrate and dye the polyester fibers. Thus the printing liquid is fixed in the material.

In instant (or “on-line”) sublimation systems, printing liquid (e.g. sublimation ink) is first directly fired over the textile. Then the textile is submitted to a suitable sublimation temperature/energy to sublimate the printing liquid and fix the printing liquid in the textile. This is different to transfer sublimation systems which use paper as a temporary vehicle for the printing liquid prior to the printing liquid being applied and sublimated into the textile.

Different sublimation printing liquid (e.g. inks) may sublimate at different sublimation temperatures and may have different transfer/sublimation rates. For example, sublimating a magenta area fill may take place using less energy compared to the energy for sublimating a cyan area fill. Also, for example, the total energy to sublimate small areas or little content may be less than the energy to sublimate large saturated areas. This different printing liquid behaviour and different image nature is not generally taken into account.

It may be desirable to account for the type of printing liquid being used when determining the sublimation parameters to use to fix the printing liquid in the material. It may be desirable to account for the nature of the image (e.g. printing liquid/ink density, image size) printed on the material when determining the sublimation parameters to use to fix the printing liquid in the material.

Examples disclosed herein may account for the type(s) of printing liquid (e.g. ink), and/or the nature of the image, when determining the sublimation energy parameters to use. That is, the image content is accounted for in determining an energy to use for subliming printing liquid in sublimation printing. Improved selection of sublimation parameters may reduce undesired image quality defects, such as bleeding and ghosting, in sublimation printed images as disclosed herein. Undesirable textile effect, such as rigidity and yellowing, may be reduced by improved selection of sublimation printing parameters as disclosed herein. Thus, methods disclosed herein which account for the image content to be printed and sublimated, may provide improved sublimation printing by improved selection of the sublimation energy used to fix the printing liquid.

Examples disclosed herein describe the use of “ink”, which is given as an example of a printing liquid. Ink density (an example of printing liquid density) may be understood as the proportion of an area to be filled with a particular coloured ink. For example, a unit square to be coloured completely in black ink would have a 100% black ink density. A unit square to be coloured in 50% cyan and 50% yellow ink would have 50% cyan ink density and 50% yellow ink density. For a four colour print (CMYK) then a maximum ink density of 400% is possible, 100% of each of the four coloured inks.

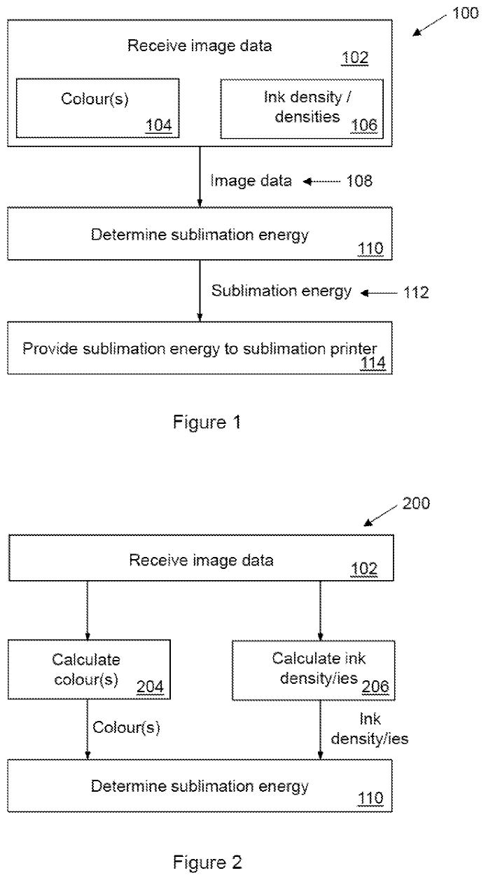

FIG. 1 shows a method 100 for sublimation printing according to some examples. The method comprises receiving 102 image data of an image to be sublimation printed. The image data comprises one or more colours to be printed 104, and a corresponding ink density of the one or more colours 106.

Based on the received image data 108, the method determines a sublimation energy 110 to use to transfer printed ink representing the image into a material. The determined sublimation energy 112 is provided to a sublimator of a printer 114 for transferring the image. The sublimation energy may be calculated in any suitable energy unit, such as a temperature unit (e.g. ° C., ° F.), or energy/power unit with associated time (e.g. J, kJ, W).

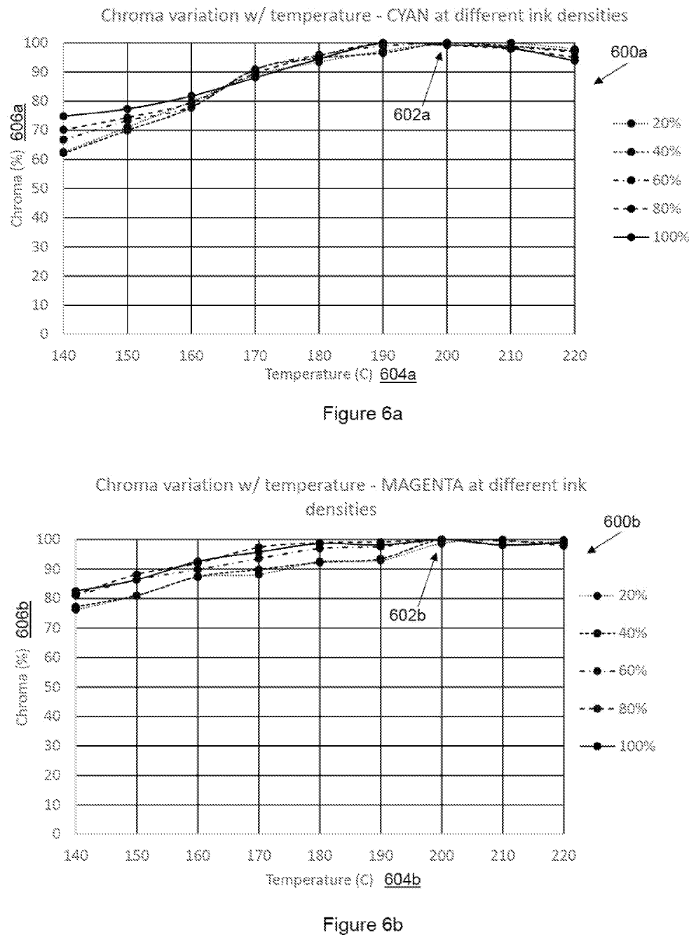

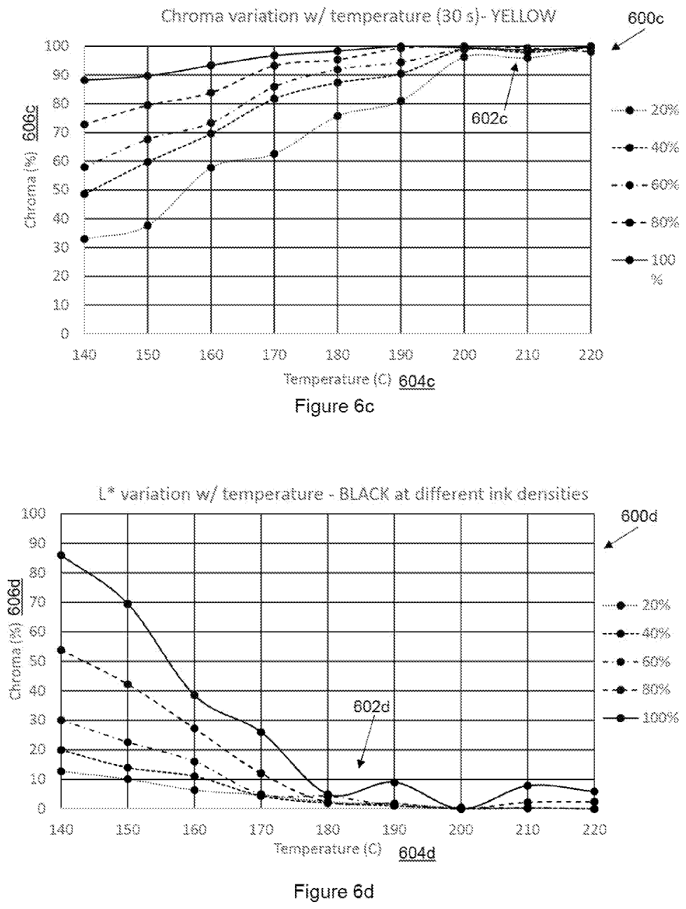

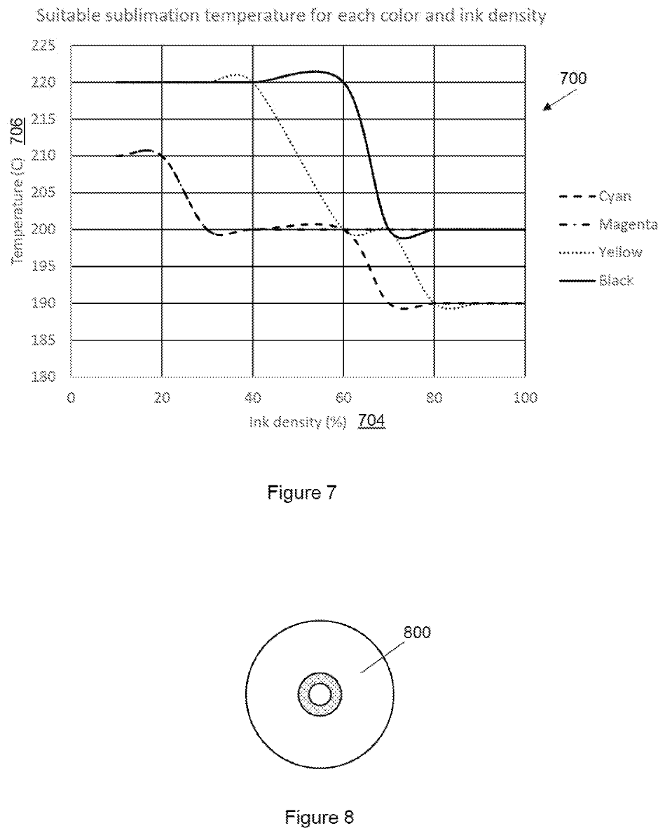

In some examples, the method 100 determines the sublimation energy 110 based on a predetermined relationship between the one or more colours to be printed 104, the corresponding ink density of the one or more colours 106, and sublimation energy. For example, the predetermined relationship may indicate, for a particular colour ink and a particular density of coverage of that ink, a suitable temperature or temperature range at which the particular ink at the particular density may be transferred by sublimation heating to the material the ink is printed on in a stable way (e.g. without detrimental effects to the material being printed on or the ink forming the image on the material). This is discussed in more detail in relation to FIGS. 6a-6d and 7 below.

In some examples the image data may be received 102 as an indication of the colour(s) 104 and an indication of the corresponding ink density or densities 106. FIG. 2 illustrates a method 200 for determining a sublimation energy from received image data according to some examples. The image data may be received 102, for example as an image file, which is processed to calculate the colour(s) 204 and corresponding ink density or densities 206 for printing the image, and from these calculated parameters 204, 206, the sublimation energy 110 for printing the image may be determined.

In other words, the method may comprise calculating, from the received image data, 102 one or more of the one or more colours to be printed 204; and the ink density of the one or more colours 206. The calculation(s) may comprise, for example, extraction of one or more colour values from the image file, colour analysis of the image represented by the image file to determine the coloured ink to print the image, extraction of one or more ink density or colour density values from the image file, or density analysis of the image represented by the image file to determine the densities of one or more colours of ink to print the image. In some examples, calculating the ink density of the one or more colours comprises determining, from the image data, an area of the image and a volume of ink to be dispensed in the area to print the image. This may be considered to be a density type analysis.

For example, an analysis of the data to be printed may be based in internal densitometer data calculations. The amount of ink fired per swath may be determined through a module of the sublimation printer or of the sublimator of the printer which is to perform pixel counting or density counting, to determine the ink density to be applied in various regions of the printed image. In the example of density counting, this may provide an estimate of the amount of ink that will be printed on a substrate or material. This may be done by counting the number of times that each colour pixel occurs in each density counting region. The height of this region may be the same as the height of the swath being processed. The region width may be programmable and may be set, for example to 64, 128, 256 or 512 pixels. The amount of ink pixels per densitometer region may be counted. The width of the densitometer region may be programmable, and for example may be 64, 128, 256 or 512 pixels wide. The number of densitometer regions may vary dependent on the width of the densitometer region and the number of 512 pixel wide columns being processed. A count value may be stored for each densitometer region. From this, the density of ink in the image may be determined.

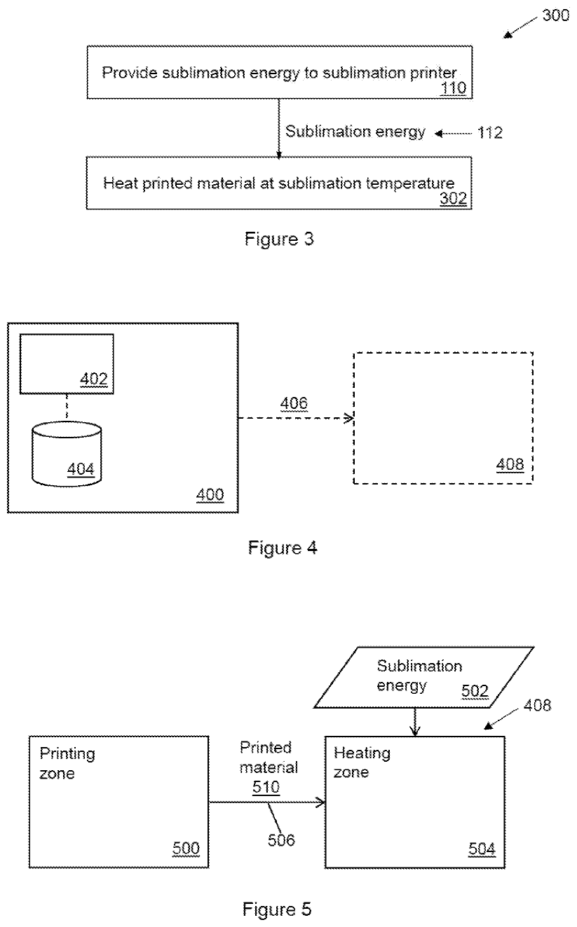

FIG. 3 depicts a method 300 of sublimation printing according to some examples. Following determination of the colour(s) 104, 204 and ink density/densities 106, 206 to print the image, the sublimation energy 112 is determined 110 and provided to the sublimator of the printer 110. The material printed with ink representing the image may then be heated at the determined sublimation temperature 302 to transfer the printed ink into the material. For example, the sublimation temperature 112 may be provided to a heating zone, heating controller, or other element of a sublimator of the printer for controlling the heat to be applied to the printed material.

FIG. 4 illustrates an example of an apparatus 400 for sublimation printing according to some examples. The apparatus 400 comprises a processor 402, a computer readable storage 404 coupled to the processor 402; and an instruction set to cooperate with the processor 402 and the computer readable storage 404. The instruction set is to determine a sublimation temperature 112 at which to heat a substrate printed with an image in sublimation ink to fix the sublimation ink in the substrate. The determination is based on a predetermined relationship between ink colour, ink density and ink sublimation temperature. The determined sublimation temperature 112 is provided (e.g. via an electrical or communications connection) 406 to a sublimator of a printer 408 for fixing a print of the image in the substrate. The apparatus may be part of a sublimation printer in some examples, part of a sublimator of a printer in some examples, or may be external to and in communication with a sublimation printer or sublimator of a printer in some examples (e.g. a remote server).

In some example apparatuses 400, the instruction set may cooperate with the processor 402 and the computer readable storage 404 to obtain data indicating the one or more colours to be printed 104, 204 and the ink density of the one or more colours 106, 206; and determine the sublimation temperature 110 from the obtained data based on a predetermined relationship, such as that discussed below in FIG. 7.

In some example apparatuses 400, the instruction set may cooperate with the processor 402 and the computer readable storage 404 to obtain image data 102 representing the image printed in sublimation ink; and analyse the obtained image data to obtain the data indicating the one or more colours to be printed 104, 204 and the ink density of the one or more colours 106, 206. This may be, as discussed above, through a density type analysis.

FIG. 5 shows an example of a sublimation printing system 408 according to some examples. The illustrated example sublimation printing system 408 comprises a printing zone 500, and a heating zone 504. Ink may be dispensed in the printing station 500 onto the material to form the image. The heating station 504 is to receive a determined energy 502 at which the material, printed with the image in ink in the printing zone, is to be heated to sublimate the ink into the material. The energy 502 is determined based on one or more colours of ink in the image and an amount of ink used to print the image. The heating station 504 is to then receive the material 510 printed with the image from the printing zone 500, and heat the material using the received determined energy 502.

In some examples, in which the printing station 500 is to print the image in ink on the material, the sublimation printing system 506 further comprises a transfer member 506 configured to move the material 510 printed with ink from the printing zone 500 to the heating zone 504 for heating.

FIGS. 6a-6d illustrate example results 600a-600d indicating colour purity variation 606a-606d with temperature 604a-604d for different colour inks at different ink densities for a tested ink. The methods described herein may be applied to other sublimation inks which may exhibit different colour purity with temperature characteristics than those illustrated in FIGS. 6a-6d. FIG. 6a illustrates the chroma—temperature variation 600a for cyan ink, FIG. 6b illustrates the chroma—temperature variation 600b for magenta ink, FIG. 6c illustrates the chroma—temperature variation 600c for yellow ink, and FIG. 6d illustrates the L*(lightness value)—temperature variation 600d for black ink.

Chroma is a measure of colour purity, for example with lower chroma values indicating less pure colours (e.g. pastel shades) and higher chroma values indicating purer (e.g. brighter) colours. A chroma value of 100% is an ideal purest colour and may be desirable to achieve. The colour purity measurement in these examples is given as “chroma”, but other colour purity measures may also be considered. For example, colour purity may be measured as “colourfulness”, defined for example as “an attribute of a visual perception according to which the perceived colour of an area appears to be more or less chromatic”. Colour purity may be measured in terms of “saturation”, defined for example as “colourfulness of an area judged in proportion to its brightness”. Chrome may be defined as “colourfulness of an area judged as a proportion of the brightness of a similarly illuminated area that appears white or highly transmitting”.

The lightness value, L*, is an equivalent indication of the purity of the colour black, with higher L* values indicating less pure black (e.g. grey shades) and lower L* values indicating purer (e.g. darker) black. L*, represents the darkest black at L*=0, and the brightest white at L*=100 An L* value of 0% is an ideal purest black and may be desirable to achieve.

As discussed above, determining the sublimation energy (e.g. temperature) to be used to sublimation print a particular image may be based on a predetermined relationship between the one or more colours to be printed, the corresponding ink density of the one or more colours, and sublimation energy. In some examples, such a predetermined relationship may be based on variation of a saturation level 606a-606d (e.g. a chroma, colour purity, or L*level) of the one or more colours to be printed with sublimation temperature 604a-604d at a plurality of ink densities. Example variations in saturation levels of different colour inks with temperature 600a-600d are indicated in FIGS. 6a-6d. The predetermined relationship in some examples may therefore be based on experimental results.

From FIGS. 6a-6d it may be seen that magenta, yellow and black inks increase their chroma/decrease their L* value with increasing temperature and, after a particular temperature 602b-d, the chroma/L* values remain constant. However, with cyan ink the chrome value increases with increasing temperature until a particular temperature 602a is reached (around 200° C. in this example), after which (i.e. at higher temperatures above around 200° C.), the chrome value starts to decrease again. This effect is more pronounced at higher densities of cyan ink.

Using the information in FIGS. 6a-6d, a temperature for each colour ink and ink density can be obtained which provides a maximum chroma (for cyan, magenta and yellow ink) or minimum L* value (for black ink) which is desirable. Note that in this example, the behaviour of cyan ink chroma with increasing temperature is a variable to take into account when deciding the amount of energy to be applied to a certain image. For example, the temperature to use to fix a multi-coloured image printed in sublimation ink may not necessarily be the highest temperature of the temperatures of the individual inks giving a maximum chrome (and/or minimum L*) value, because at temperatures beyond around 200° C., the chrome quality of cyan ink begins to degrade.

Thus, in some examples, image data may comprise a plurality of colours to be printed, and determining the sublimation energy may comprise determining a plurality of colour-specific sublimation energies of each of the plurality of colours to be sublimated; and determining the sublimation energy to use to transfer the image to the printed material from the plurality of colour-specific sublimation energies.

In some examples, even if there is no ink present which, as indicated for cyan ink in FIG. 6a, produces a decrease in chroma beyond a particular temperature, it may be undesirable to use a sublimation temperature which is too high (i.e. above a threshold temperature for the material being printed) because this may damage the underlying material being printed (e.g. the material may stiffen or yellow). Therefore, knowing a temperature/energy at which a particular sublimation ink provides a chrome above an acceptable chroma/colour purity threshold may be used to reduce damage to heat sensitive inks and/or heat sensitive materials which begin to degrade above certain temperatures.

The examples discussed above account for the chrome values of different ink colours of different densities. In some examples, the time taken to perform sublimation may be taken into account, as different inks may provide different chroma variations in dependence on the time taken to sublimate the ink into the material.

In some examples, the properties of the printed material may be accounted for, as different materials (e.g. different polyester blends) may, for example, start to show yellowing at different high temperatures, and/or may exhibit reduced ink fixing (leading to bleeding or ink loss from the printed material) at different lower temperatures, for example. Thus the predetermined relationship indicating a suitable sublimation temperature may be material-specific.

FIG. 7 illustrates a relationship between sublimation temperature 706 and ink density 704 for stable sublimation printing of cyan, magenta, yellow, and black inks as investigated in this example. The data in FIG. 7 is taken from the data presented in FIGS. 6a-6d. For example, FIG. 6a shows that cyan ink provides a peak chrome value (of around 100%) at a temperature of 210° C. at 20% ink density, provides a peak chroma value (of around 100%) at a lower temperature of 200° C. at 40% and 60% ink densities, and provides a peak chroma value (of around 100%) at a lower still temperature of 190° C. at 80% and 100% ink densities. As another example, FIG. 6d shows that black ink provides a peak L* value of around 0% at a temperature of 220° C. at 20%, 40% and 60% ink density, and provides a peak L* value of around 0% at a lower temperature of 200° C. at 80% and 100% ink densities.

Thus it may be said that determining the sublimation energy may be based on a predetermined relationship 700, as shown in FIG. 7, between the one or more colours to be printed, the corresponding ink density 704 of the one or more colours, and sublimation energy 706, The predetermined relationship 700 may be based on variation of a saturation level of the one or more colours to be printed 606a-606d with sublimation temperature 604a-604d at a plurality of ink densities, as shown in FIGS. 6a-6d.

The image data may comprise a plurality of colours to be printed. Determining the sublimation energy in some examples may comprise determining a plurality of colour-specific sublimation energies of each of the plurality of colours to be sublimated; and determining the sublimation energy from the plurality of colour-specific sublimation energies. For example, the relationship of FIG. 7 may be used to determine a compromise in temperature of two colour inks are to be used (of the same or different ink densities) which do not have the same suitable (or stable) sublimation temperature.

In an example scenario, an image may have an area fill with yellow ink at 50% ink density and magenta ink at 50% ink density. From the relationship of FIG. 7, a suitable temperature for sublimation for the yellow ink would be 210° C. while for magenta a suitable ink sublimation temperature would be 200° C. Choosing 210° C. to sublimate this image content would be safe for both colorants because, from FIG. 6b, while magenta provides a high chroma value at a sublimation temperature of 200° C., it still provides a high chroma value at 210° C. From FIG. 6c it can be see that yellow provides a high chroma value at a sublimation temperature of 210° C., but if the sublimation temperature is reduced at 2000, the chroma value may decrease which is undesirable.

In another example scenario, an image may have an area fill with yellow ink at 40% ink density and cyan ink at 100% ink density. For the 40% density yellow ink, a suitable temperature as shown in FIG. 7 is 220° C., while 190° C. is a suitable sublimation temperature for the cyan ink. While 40% density yellow ink provides a high chroma value at a sublimation temperature of 220° C., and still provides a high chroma value at 210° C. (as shown in FIG. 6c), at temperatures lower than 210° C. the chroma value begins to decrease. However, from FIG. 6a, it can be seen that 100% density cyan provides a high chroma value at a sublimation temperature of 190° C., and a high chroma value at 210° C., but if the sublimation temperature is raised further to 220° C., the cyan chroma value begins to decrease which is undesirable. Thus 216° C. is a good compromise temperature at which to sublimate this combination of ink colours and densities.

Of course, the illustrated relationships are examples of a particular tested ink batch on a particular fabric. The example predetermined relationship of FIG. 7 indicates an overall decrease in sublimation temperature as ink density increases. Other batches of ink, and different fabrics, may provide different relationships. However, using a stability relationship determined for the particular inks and material used may provide improved sublimation printing. other inks and materials may behave according to different absolute relationship values but follow the same trends as those shown in the examples of FIGS. 6a-6d and FIG. 7.

The above examples consider absolute desirable sublimation temperatures and, where combinations of inks are used, a margin of sublimation temperature about the plotted desirable sublimation temperature is considered to find a compromise temperature for all the inks used in printing an image. Thus, in some examples, the predetermined relationship may indicate a temperature stability range of the one or more colours to be printed; and determining the sublimation energy may comprise determining a sublimation energy within the temperature stability range of the one or more colours to be sublimated. In some examples, the image data may comprise a plurality of colour to be printed, and determining the sublimation energy may comprise determining a plurality of colour-specific sublimation energies within the temperature stability range of each of the plurality of colours to be printed; and determining the sublimation energy from the plurality of colour-specific sublimation energies within a multi-colour temperature stability range determined from the temperature stability ranges of each of the plurality of colours.

FIG. 8 depicts a computer readable medium according to some examples. FIG. 8 may be considered to show a computer readable storage medium having executable instructions stored thereon which, when executed by a processor, cause the processor to perform any method disclosed herein. The machine readable storage 500 can be realised using any type or volatile or non-volatile (non-transitory) storage such as, for example, memory, a ROM, RAM, EEPROM, optical storage and the like.

Also disclosed herein is an apparatus (e.g. the apparatus 400 of FIG. 4, or an apparatus/device 408) which may perform any of the methods shown in FIGS. 1-3 or any other method disclosed herein. Such an apparatus may comprise a processor 402 and a computer readable storage 800 coupled to the processor; and an instruction set to cooperate with the processor 402 and the computer readable storage 800, wherein the instruction set is to perform any of the methods disclosed herein.

Throughout the description and claims of this specification, the words “comprise” and “contain” and variations of them mean “including but not limited to”, and they are not intended to (and do not) exclude other components, integers or elements. Throughout the description and claims of this specification, the singular encompasses the plural unless the context suggests otherwise. In particular, where the indefinite article is used, the specification is to be understood as contemplating plurality as well as singularity, unless the context suggests otherwise.

1. A method comprising:
receiving image data of an image to be sublimation printed, the image data comprising one or more colours to be printed, and a corresponding printing liquid density of the one or more colours;
based on the received image data, determining a sublimation energy to use to transfer printed printing liquid representing the image into a material; and
providing the determined sublimation energy to a sublimator of a printer for transferring the image.

2. The method of claim 1, wherein determining the sublimation energy is based on a predetermined relationship between the one or more colours to be printed, the corresponding printing liquid density of the one or more colours, and sublimation energy.

3. The method of claim 2, wherein the predetermined relationship is based on variation of a saturation level of the one or more colours to be printed with sublimation temperature at a plurality of printing liquid densities.

4. The method of claim 1, wherein the image data comprises a plurality of colours to be printed, and wherein determining the sublimation energy comprises:
determining a plurality of colour-specific sublimation energies of each of the plurality of colours to be sublimated; and
determining the sublimation energy from the plurality of colour-specific sublimation energies.

5. The method of claim 2, wherein:
the predetermined relationship indicates a temperature stability range of the one or more colours to be printed; and
determining the sublimation energy comprises determining a sublimation energy within the temperature stability range of the one or more colours to be sublimated.

6. The method of claim 5, wherein the image data comprises a plurality of colours to be printed, and wherein determining the sublimation energy comprises:
determining a plurality of colour-specific sublimation energies within the temperature stability range of each of the plurality of colours to be printed; and
determining the sublimation energy from the plurality of colour-specific sublimation energies within a multi-colour temperature stability range determined from the temperature stability ranges of each of the plurality of colours.

7. The method of claim 1, wherein the method comprises calculating, from the received image data, one or more of:
the one or more colours to be printed; and
the printing liquid density of the one or more colours.

8. The method of claim 7, wherein calculating the printing liquid density of the one or more colours comprises determining, from the image data, an area of the image and a volume of printing liquid to be dispensed in the area to print the image.

9. The method of claim 1, wherein the method comprises heating the material printed with printing liquid representing the image at the determined sublimation temperature to transfer the printed printing liquid into the material.

10. An apparatus comprising:
a processor;
a computer readable storage coupled to the processor; and
an instruction set to cooperate with the processor and the computer readable storage to:
determine a sublimation temperature at which to heat a substrate printed with an image in sublimation printing liquid to fix the sublimation printing liquid in the substrate, the determination based on a predetermined relationship between printing liquid colour, printing liquid density and printing liquid sublimation temperature; and
provide the determined sublimation temperature to a sublimator of a printer for fixing a print of the image in the substrate.

11. The apparatus of claim 9, wherein the instruction set is to cooperate with the processor and the computer readable storage to:
obtain data indicating the one or more colours to be printed and the printing liquid density of the one or more colours; and
determine the sublimation temperature from the obtained data based on a predetermined relationship.

12. The apparatus of claim 11, wherein the instruction set is to cooperate with the processor and the computer readable storage to:
obtain image data representing the image printed in sublimation printing liquid; and
analyse the obtained image data to obtain the data indicating the one or more colours to be printed and the printing liquid density of the one or more colours.

13. A non-transitory computer readable storage medium having executable instructions stored thereon which, when executed by a processor, cause the processor to:
receive data representing an image to be sublimation printed,
determine one or more printing liquid colours and corresponding printing liquid densities of the one or more colours using the received data;
determine a sublimation energy at which to heat a material printed with printing liquid forming the image to fix the printing liquid in the material; and
providing the determined sublimation energy to a heater.

14. A sublimation printing system comprising:
a printing zone; and
a heating zone;
wherein the heating station is to:
receive a determined energy at which a material, printed with an image in printing liquid in the printing zone, is to be heated to sublimate the printing liquid into the material, the energy determined based on one or more colours of printing liquid in the image and an amount of printing liquid used to print the image;
receive the material printed with the image from the printing zone; and
heat the material using the received determined energy.

15. The sublimation printing system of claim 14, wherein the printing station is to print the image in printing liquid on the material; the sublimation printing system further comprising:
a transfer member configured to move the material printed with printing liquid from the printing zone to the heating zone for heating.
